(19) United States
(12) Patent Application Publication
(10) Pub. No.: US 2005/0140159 A1
(43) Pub. Date: Jun. 30, 2005

(54) Sliding storage compartment located between the frame rails of a vehicle

(76) Inventor: Robert Barber, San Mateo, CA (US)

Correspondence Address: Robert Barber, 502 Avila Rd., San Mateo, CA, 94402, US

(21) Appl. No.: 10/747,565

(22) Filed: Dec. 30, 2003

(51) Int. Cl. B60N 3/12

(52) U.S. Cl. 296/37.6

(57) ABSTRACT

A sliding storage device which may be mounted between the frame rails of a truck. The sliding storage device includes sliding rails adapted for mounting in a substantially horizontal orientation to the bed of the truck and the frame rails of the truck. The sliding storage device having three sides and a bottom such that the top is open for placing materials in for storage. A first panel is hingedly attachable to the front of the sliding storage device for access to the locking mechanism. The locking mechanism secures the the sliding storage device in a closed position between the frame rails of a vehicle.

### SUMMARY OF THE INVENTION

The present invention provides a pickup truck sliding toolbox assembly. The principal advantage of the present invention is that the assembly takes advantage of the space between the frame rails of a vehicle. This previously unused space permits the user of a pickup truck to store items and continue to take full advantage of the wide variety of uses of a standard truck bed.

Accordingly, the present invention is directed to a sliding toolbox storage assembly for a pickup pickup truck in which the sliding toolbox is located between the frame rail of the pickup truck. The assembly comprises: (a) a toolbox mountable between the frame rials of the truck; and (b) sliding hinges allowing the toolbox to slide from a closed position to an open position so that mobile equipment can be loaded and unloaded from the toolbox. The toolbox is preferably integrated into the bumper.

The toolbox includes sliding hinges mountable on the inner side of the pickup frame rails so as to extend substantially outside of the truck and a tool storage compartment extending substantially the length of the attachment member and being mounted thereto so as to undergo movement between closed and open usage positions relative thereto and the truck. More particularly, the frame rails and tool storage compartment are attached by sliding hinges to one another along first adjacent longitudinal edges thereof.

Also, the toolbox includes at least one latching mechanism for latching the toolbox in the closed position.

The toolbox assembly when attached to the frame rails and disposed in a closed or open position allows the tailgate to function in a normal manner. Such that the tailgate can be opened to its horizontal position without interference with toolbox. Further the toolbox may include a flat sheet which is disposed in the horizontal position providing a sturdy workbench.

The present invention is also directed to stationary toolbox located between the frame rails of a pickup truck. A hinged opening on the front of the toolbox allows for access to the stationary toolbox.

Thus it will be appreciated that the disclosed invention solves the problems of a storage box which cannot be conveniently accessed and to allow full use of the bed of the truck and tailgate to carry materials in a conventional manner.

It should also'be understood that while the above and other advantages and results of the present invention will become apparent to those skilled in the art from the following detailed description and accompanying drawings, showing the contemplated novel construction, combinations and elements as herein described, and more particularly defined by the appended claims, it is understood that changes in the precise embodiments of the herein disclosed invention are meant to be included within the scope of the claims, except insofar as they may be precluded by the prior art.

### DRAWINGS

The accompanying drawings illustrate preferred embodiments of the present invention according to the best mode presently devised for making and using the instant invention, and in which:

FIG. 1 is a perspective view of a sliding storage compartment in its open position.

FIG. 2 is an elevational view of the sliding storage compartment in the closed position attached between the frame rails of a vehicle.

FIG. 3 is an elavational view of the sliding storage compartment in the open position attached between the frame rails of a vehicle.

FIG. 4 is a detailed perspective view of the sliding storage compartment in the open position.

### DETAILED DESCRIPTION OF PREFERRED EMBODIMENTS

While the invention will be described and disclosed here in connection with certain preferred embodiments, the description is not intended to limit the invention to the specific embodiments shown and described here, but rather the invention is intended to cover all alternative embodiments and modifications that fall within the spirit and scope of the invention as defined by the claims included herein as well as any equivalents of the disclosed and claimed invention.

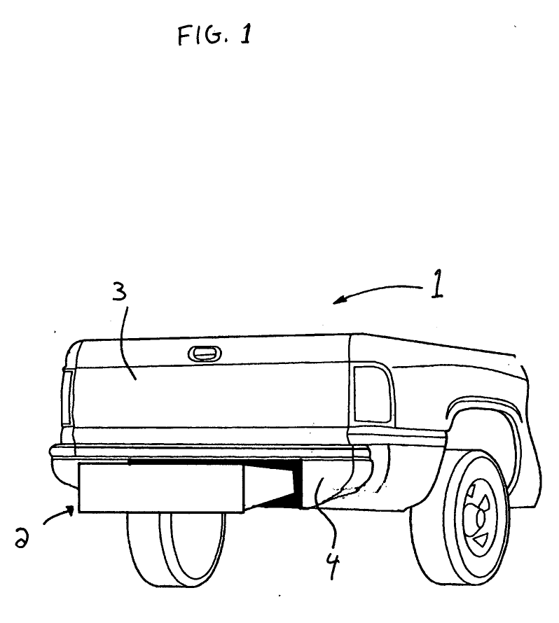

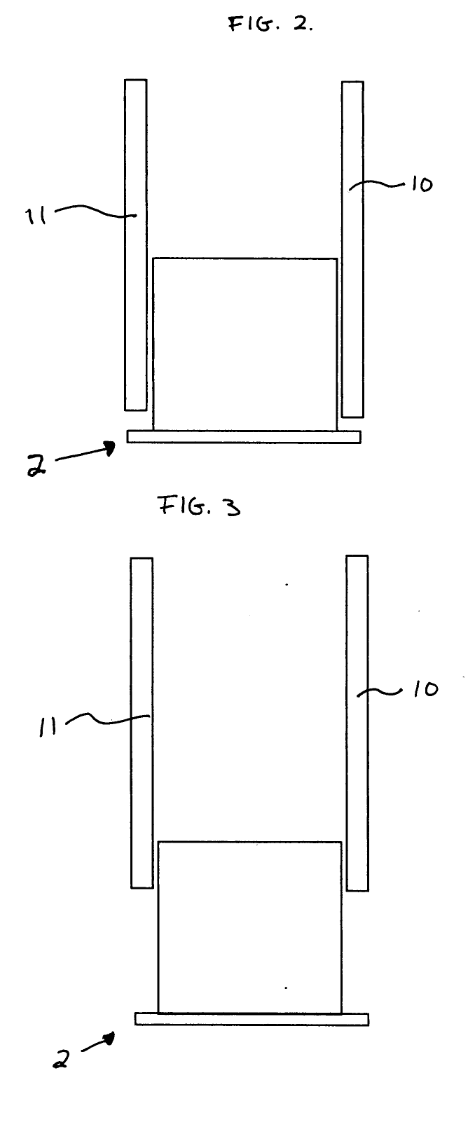

Referring to FIG. 1 where a sliding storage compartment 2 made in accordance with the principles taught herein is shown in the open position mounted between the frame rails as show in FIG. 2 and FIG. 3 which show the truckbed portion of a pickup truck. The truck includes a bed 1, the bed having a floor and support means for accepting a tailgate and mounted on a plurality of frame rails. Further the truck includes a bumper 4 which has been modified to work with the sliding storage compartment. The stock bumper can be modified by cutting an appropriate size opening to allow the sliding storage container to extend into the open position or a new bumper integrated with the sliding storage container may be attached to the truck. The sliding storage compartment 2 also serves a work space when in the open position. The sliding storage compartment is preferably attached to the frame rails with a 29 inch sliding hinge available from www.cabinetparts.com part number 566H BLUM TANDEM FX 29” W/LD. The sliding hinge 20 is then attached to the frame rails of the truck. In the preferred embodiment the sliding storage compartment is capable of holding at least thirty pounds of items. Non limiting examples of items to be stored in the sliding storage container are tools, hardware and firearms. In another embodiment the sliding storage container can hold several hundred pounds. In another alternative embodiment the sliding storage container can hold five pounds. In another alternative embodiment the sliding storage container is located between the frame rails and attached to the bottom of the truck bed. Further, an alternative embodiment of the storage container is a fixed position storage container in which the storage container is located between the truck frame rails with access to the fixed storage container obtained by a hinged door on the outside of the storage container. In another embodiment, the sliding storage container has a removable top for further securing the items to be stored and provide a work surface. In another embodiment, a piece of material is attached between the bottom of the frame rails creating an enclosed storage compartment between the frame rials. In yet another embodiment a sliding storage container is held between the truck frame rails by a series of support bars connected between the truck frame rails in a perpendicular fashion.

FIG. 2 is a view from below the vehicle showing how the sliding storage compartment 2 is located between the frame rails 10 and 11 of the vehicle. The sliding storage compartment is in a closed position in FIG. 2. In the preferred embodiment the storage container is attached to the frame rails by a sliding hinge as previously described. In an alternative embodiment the storage compartment is permanently attached to the frame rails in a fixed position. The fixed position storage container has a lower costs of materials and ease of installation.

FIG. 2 is a view from below the vehicle showing how the sliding storage compartment 2 is located between the frame rails 10 and 11 of the vehicle and attached to the frame rails with a sliding hinge allowing the sliding storage compartment to move from the closed position as shown in FIG. 2 to the open position as shown in FIG. 3.

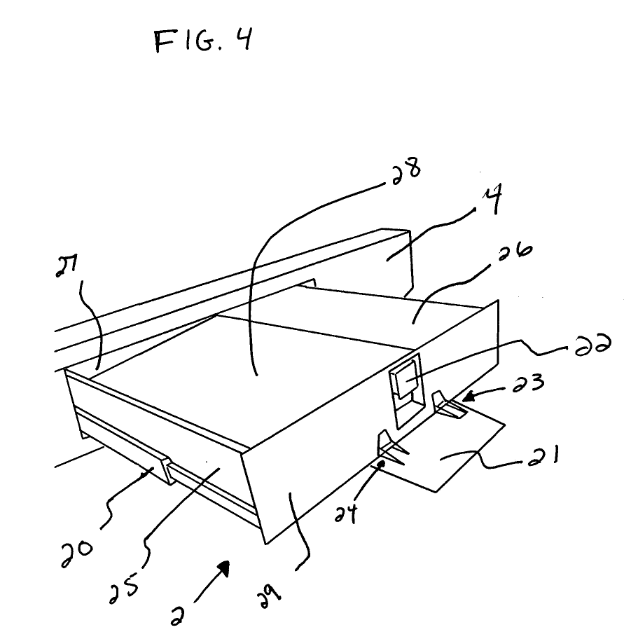

FIG. 4 is a detailed elevational view of the sliding storage compartment in the open position. In the preferred embodiment side 29 of the sliding storage compartment is twenty inches wide by four inches high. The sides 25 and 26 are four inches high by thirty inches long. Attached to sides 25 and 26 are sliding hinges 20. A non limiting example of a sliding hinge is the Blum 566H7500P 29 inch drawer slider. The sliding hinges are also attached to the frame rails of the truck enabling the drawer to slide open and closed. The side 27 of the sliding storage compartment is four inches high by twenty inches wide. The side 28 is twenty inches wide by thirty inches long. In the preferred embodiment the sliding storage compartment is made of one sixteenth thick galvanized steel. Other non limiting examples of suitable materials for the sliding storage compartment are fiberglass, plastic, aluminum, wood and stainless steel. Further, the dimensions of the sliding storage container may vary based on the distance between the frame rails of different size and types of trucks. A latching mechanism 22 is shown on the side 29 of the sliding storage container 2 such that the sliding storage container can be locked in the closed position. A plate 21 is attached on the side 29 of the latching mechanism by two hinges 23 and 24 such that a license plate may be attached to the plate 21 so that one can access the latching mechanism by rotating the license plate attached to the plate 21 to reveal the latching mechanism 22. It is important to note that while the simple locking device discussed herein is the best method known, it is contemplated that other known locking and latching devices may be incorporated into and supported by the frame structure taught herein to allow the replacement of the instant invention into the existing fittings and structure of a vehicle on which the instant invention is to mounted.

It is important to note that while the invention has been shown serving as a sliding storage container, it is contemplated that the structure and principles taught herein allow the manufacture and use of sliding work benches, sliding power tools, or the like attached between the frame rails in a substantially horizontal orientation when in an open or closed position. However, the structure of the instant invention is particularly well suited for use of the device in place the tailgate found in most trucks.

In an alternative embodiment the sliding storage container is subdivided into a plurality compartments for storing smaller items.

It is important to note that while the simple locking device discussed herein is the best method known, it is contemplated that other known locking and latching devices may be incorporated into and supported by the frame structure taught herein to allow the replacement of the instant invention into the existing fittings and structure of a vehicle on which the instant invention is to mounted.

Thus it can also be appreciated that the above described embodiments are illustrative of just a few of the numerous variations of arrangements of the disclosed elements used to carry out the disclosed invention. Moreover, while the invention has been particularly shown, described and illustrated in detail with reference to preferred embodiments and modifications thereof, it should be understood by that the foregoing and other modifications are exemplary only, and that equivalent changes in form and detail may be made without departing from the true spirit and scope of the invention as claimed, except as precluded by the prior art.

1. A storage container for mounting between the frame rails of a truck, the bed of the truck having a floor and a bumper having means for accepting a sliding storage container, the storage container comprising:
a container adapted for mounting to the frame rails of the truck, the container having a lower portion, an upper portion and sides, the sides being attached by a sliding hinge mechanism to the frame rails;
and a bumper having an opening to allow the sliding storage container to slide to the open position.

2. A storage container according to claim 1 wherein said bumper comprises an opening large enough to allow said storage compartment to slide open.

3. A bumper according to claim 1 wherein said sliding hinges are attached to the storage container and to said bumper.

4. A storage container according to claim 1 wherein said storage container comprises a locking mechanism for locking the sliding storage container in the closed position.

5. A storage device according to claim 1 wherein said frame rials further comprise means for mounting said storage device in a manner that the tailgate remains functional.

6. A storage device for mounting between the frame rails of a truck, the storage device comprising:
a means for mounting the storage between the frame rials of a truck;
and a bumper being adapted for accessing a storage container located between the frame rails of the truck.

7. A storage device according to claim 6 wherein said storage device has a door panel, the door panel being hingedly attached to said storage container in a generally parallel arrangement to said bumper.

8. A storage device according to claim 6 wherein said storage device is mounted in a substantially parallel orientation to the frame rails of the truck.

9. A vehicle having a bed defining a cargo carrying space, the bed comprising a floor attached to a plurality of frame rials, the vehicle characterized in that the frame rails further comprise:
a storage container located between the frame rails of the vehicle;
a bumper attached to the frame rials;
a bumper adapted for use with said storage container.

10. A kit for modifying a vehicle having a bed defining a cargo carrying space, the bed having front and rear ends and a plurality of frame rails, the kit comprising:
a means for installation of a sliding storage container between and within the frame rails of a vehicle;
and a bumper adapted to work with said sliding storage container.
